(19) United States
(12) Patent Application Publication
(10) Pub. No.: US 2006/0273548 A1
(43) Pub. Date: Dec. 7, 2006

(54) Dolly and trailer jack combination and method of use

(76) Inventor: Michael Bishman, Orange, CA (US)

Correspondence Address: PATENT LAW & VENTURE GROUP, 2424 S.E. BRISTOL, SUITE 300, NEWPORT BEACH, CA, 92660, US

(21) Appl. No.: 11/408,893

(22) Filed: Apr. 21, 2006

Related U.S. Application Data
(63) Continuation-in-part of application No. 10/626,751, filed on Jul. 23, 2003, now abandoned.

(51) Int. Cl. B62D 53/08

(52) U.S. Cl. 280/476.1

(57) ABSTRACT

A wheeled dolly is enabled for rolling movement on a supporting surface. A centrally positioned sidewall extends upwardly from a top surface of the platform. A vertical jacking device is rested in contact with the supporting surface interior of the sidewall. The sidewall is tall enough so that a jack foot is restrained within the sidewall, and therefore not able to move laterally on the platform so as to tip it. A trailer is joined with the jacking device enabling manual movement of the trailer and its load by maneuvering the platform.

### CROSS-REFERENCE TO RELATED APPLICATIONS

This is a continuation-in-part application of U.S. patent application Ser. No. 10626751, filed Jul. 23, 2003 which is now copending, which is incorporated herein by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTTED ON A COMPACT DISC

Not applicable.

### REFERENCE TO A “MICROFICHE APPENDIX”

Not applicable.

### BACKGROUND OF THE INVENTION

1. Field of the Present Disclosure

This invention relates generally to wheeled dollies, low rolling hand trucks and the like and more particularly to such a device that is adapted particularly for engaging a trailer jack.

2. Description of Related Art including information disclosed under 37 CFR 1.97 and 1.98

English, Jr., et al., U.S. Pat. No. 6,533,524, teaches a lift dolly for lifting and transporting stand-mounted power tools and the like, with little effort. The dolly includes a pair of platforms and a wheel system having at least three castors extending downwardly from the platforms. The dolly is designed such that one step onto a latching or locking mechanism by the operator causes the wheel system to be forced downward relative to the stand thereby slightly lifting the power tool and stand off of the ground and enabling transport of same via the castors. Another step on the locking or latching mechanism disengages the wheel system and permits gravity to return the stand and tool firmly to the ground for use. Calender, U.S. Pat. No. 6,386,560, teaches a dolly for large appliances facilitating manual movement of soft drink vending machines, refrigerators, etc. The dolly has a dropped floor between each end, with the ends raised for installation of casters therebeneath. The lower central floor area is preferably only about 1.5 inches above the lower supporting surface when the dolly is resting thereon, thereby allowing a large machine to be tilted slightly and the dolly maneuvered therebeneath. The low floor also results in a very low ride height for the appliance, enabling the appliance to fit upright through a standard doorway. Carrying the appliance sideways on the dolly, also permits large vending machines to fit through a standard doorway by opening the door of the machine to narrow the effective width of the machine. A roller lever is also provided, for lifting one end of the loaded dolly for maneuvering the lifted end across thresholds and other floor discontinuities. Hamlett, U.S. Pat. No. 6,357,991, teaches an apparatus for transporting, loading and unloading a watercraft, such as a jet ski, or wheeled vehicle from the bed of a pick up truck, where the apparatus is convertible to a mobile dolly for storage of the jet ski or other object. The apparatus comprises a tiltable mechanism formed of a pair of spaced apart rails mounting a pair of pivotal and retractable legs at a first end, a winch mechanism at the opposite end, and a longitudinally movable and pivotal leg support mechanism, movable from the first end to near the opposite end. Wintz, U.S. Pat. No. 5,938,217, teaches a load handling dolly which assists in the transportation of a load P, such as a piano. A pair of cross-pieces are selectively slid beneath the load, either directly or using an intermediate support plate. A pair of side frames are disposed on either side of the load above free ends of the cross-pieces. The cross-pieces are received within extremities or eyelets of tie rods which are supported by the side frames for vertical movement by rotating a nut. As the nuts are turned, the tie rods, cross-pieces, and the load are lifted, transferring the load to two sets of wheels that rotatably mounted in the side frames. Hull, et al., U.S. Pat. No. 5,860,668, teaches a convertible chassis for a dual axle semitrailer for converting the semitrailer to a single axle trailer having an attached dolly to pull a second trailer thereon. Combs, Sr., U.S. Pat. No. 6,203,264, teaches A post-and-beam mechanism easily connectable to a standard car dolly carries on its beams a standard boat trailer, loaded with boat and outboard motor, above the front end of a towed vehicle on the dolly, with the rear, heavy end of the trailer and boat located forward most. A motor home may tow, to the destination site, the dolly thus loaded with towed vehicle, boat trailer, boat and motor. The post-and-beam mechanism is pivotably swingable from a low position for loading the loaded boat trailer thereon; to a high position for carrying the loaded boat trailer. The towing is safely done, with advantageous forward weight distribution of the carried trailer, boat and motor, and with short combined overall length of towing vehicle and towed vehicle, for easy driving and parking. When the destination site is reached, the towed vehicle is unloaded from the car dolly, and the mechanism may be lowered from the high position to the low position for unloading the boat trailer. An arrangement of pull pins and cotter keys enable part of the post-and beam mechanism to stay attached to the boat trailer, enables part to be easily disconnected and set aside, and enables the rest to remain attached to the car dolly. This permits convenient and separate independent usage of either the car dolly or the boat trailer with either the towing vehicle or the towed vehicle, or with other vehicles at or near the destination site.

The prior art teaches a lift dolly for use in conjunction with stand-mounted power tools and the like, a lift dolly for heavy appliances, a combination watercraft transportation system and dolly, a combination watercraft transportation system and dolly, a boat trailer carrier for an over car dolly, and a dolly for moving pianos and other heavy goods, but does not teach a combination dolly and vertical jacking device wherein the jacking device is affixed to a trailer, such as a boat trailer, wherein the dolly provides simple sidewalls for centering the jacking device on a platform of the dolly such that the dolly is not able to be easily upset. The present invention fulfills these needs and provides further related advantages as described in the following summary.

### BRIEF SUMMARY OF THE INVENTION

This disclosure teaches certain benefits in construction and use which give rise to the objectives described below.

A horizontal platform dolly is mounted on plural wheels, and is thereby enabled for rolling movement on a supporting surface. A sidewall extends upwardly from an top surface of the platform. A vertical jacking device is positioned in contact with the top surface and constrained to a central position on the platform. The sidewall is tall enough to prevent lateral motion of the jacking device relative to the platform. The sidewall maintains the jacking device centered on the platform so that the dolly is not easily upset when stopped abruptly. A trailer is joined with the jacking device enabling manual movement of the trailer and its load by rolling the platform on the supporting surface.

A primary objective of the present apparatus is to provide advantages not taught by the prior art.

Another objective is to provide such an apparatus capable of supporting the weight of a trailer and a trailer load in rolling motion.

A further objective is to provide such an apparatus capable of manually rolling a significant load in a lateral direction without the necessity of bolting or otherwise attaching a leg or strut which carries the load's downward forces to a rolling apparatus.

A still further objective is to provide such an apparatus capable of rolling without upset by assuring that the downward forces on the rolling apparatus are centered relative to its supporting wheels.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a perspective view of the preferred embodiment of the invention with a partial cutaway providing detail.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present apparatus and method of use.

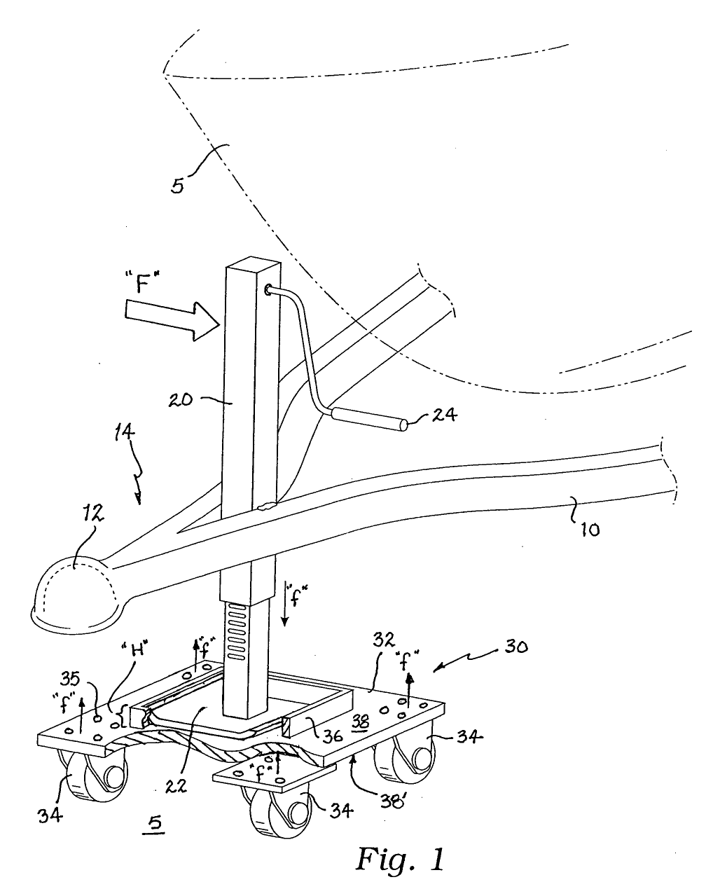

Described now in detail is a combination of a trailer 10 with an integral vertical jacking device 20 and a rolling platform dolly 30. The trailer 10 provides a hitching device 12 at its forward terminal end 14. The jacking device 20 is of the type manufactured by Fulton-Wesbar, Inc. as model 35sp28f and has a crank 24 for moving a supporting foot 22 vertically, as is well known in the art. The device 20 is fixedly engaged with the trailer 10 adjacent to the hitching device 12 preferably by welding so that the jacking device 20 is rigidly attached to the trailer 10 in a vertical attitude, as clearly shown in FIG. 1. The rolling dolly 30 is preferably made of steel plate of high structural strength and is rolled into place under the jacking device 20 prior to disconnecting the trailer 10 from a towing vehicle (not shown). A jack foot 22 of the jacking device 20 is lowered, using crank 24 until the rolling dolly 30 supports the weight of the trailer 10 and its load 5. Once this is accomplished, the hitching device 12 is able to be disconnected from the towing vehicle and the towing vehicle may be moved away from the trailer 10.

The dolly 30 provides a horizontal platform 32 having a peripheral edge as shown in FIG. 1. The platform 32 is mounted on plural wheels 34, i.e., the wheels 34 are mounted to a bottom surface 38′ of the platform 32, so that it is enabled for rolling on a supporting surface such as a driveway or garage floor 5. The wheels 34 are preferably attached to the platform 32 by bolts or rivets through holes 35 adjacent to the peripheral edge of the platform as shown. A sidewall 36 is integral with, and extends upwardly from, an up-facing top surface 38 of the platform 32. In FIG. 1 the platform 32 and sidewall 36 are cut away to show detail. FIG. 1 intends to show that the platform 32 is square or rectangular, although other shapes would function equally as well.

The vertical jacking device 20 has a jack foot 22, as stated, which is fixedly attached at the bottom terminal end of the jacking device 20, and this jack foot 22 is positioned and rested in contact with the top surface 38 interior of the sidewall 36. The sidewall 40 has a height “H” superior to the height of the jack foot 22 so that the jack foot 22 is constrained within the sidewall 36, centrally on the platform 32 as shown in FIG. 1 and it is pointed out that jack foot 22 is not able to slide laterally out of contact with surface 38 due to the sidewall 40 which acts as an obstruction to such motion. It is also pointed out that jack foot 22 is not joined with platform 32 in any way but merely rests on top surface 38.

Jack foot 22 bears the weight of trailer 10 and load 5 so that there is normally considerable downward force pressing jack foot 22 against top surface 38. Sidewall 36 is shown partially cut-away in order to show detail of how the jack foot 22 is fitted within sidewall 36 so that it is constrained to a central position on platform 32. Preferably, sidewall 40 forms a closed figure; in FIG. 1, a square, but it should be realized that sidewall 36 may form an open figure, may be other than rectangular or square and, in fact, need not be continuous; as for instance being made up of a series of sidewall portions. Sidewall 36 may for instance be made up of a series of spaced pegs (not shown) extending upwardly from surface 38. However, in order to assure that jack foot 22 is not able to slide along or off of surface 38 when a lateral horizontal force “F” is applied, sidewall 36 preferably fully surrounds the central area on surface 38 where jack foot 22 is placed and preferably the jack foot 22 is of such size as to fit tightly within sidewall 36 as is the preferred embodiment. In this manner, horizontal force “F” may be applied in any direction without fear of sliding jack foot 22 off dolly 30, or of sliding jack foot 22 away from a central position on dolly 30 whereby dolly 30 may be overturned or become unstable. It is considered a critical enablement of the present invention to secure the jack foot 22 centrally on the dolly and equally distant from each one of the wheels 34.

Preferably, the platform 32 is rectangular or square and the plural wheels 34 include four caster wheels, one of the caster wheels positioned on each one of four comers of the rectangular platform 32. This arrangement is clearly shown in FIG. 1.

Preferably, the sidewall 36 is positioned relative to the caster wheels 34 such that a downward force “f” on the vertical jacking device is transferred to the platform 32 centrally relative to upward support forces “f” on the platform exerted by the caster wheels 34. Clearly, as long as downward force “f” is within the rectangle formed by the upward forces “f” the dolly 30 will remain stable. In fact, the location of sidewall 36 is such that jack foot 22 and therefore downward force “f” is well centered in the rectangle formed by the upward forces “f.” Constraining jack foot 22 centrally on the dolly 30 optimally assures stable operation of the dolly and the jacking device when the dolly 30 is rolled along surface 5.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. An apparatus comprising in combination: a rolling dolly having a horizontal platform with a peripheral edge and a top surface, the platform mounted on plural wheels secured to a bottom surface of the platform; a sidewall integral with, and extending upwardly from the top surface of the platform; and a vertical jacking device having a jack foot resting on the top surface in a position wherein the sidewall surrounds the jack foot, thereby constraining the jack foot centrally on the top surface, the sidewall having a height superior to a height of the jack foot so that the jack foot is unable to move away from the centrally constrained position on the top surface; whereby when the platform is suddenly stopped, the jacking remains in position on the rolling dolly.

2. The apparatus of claim 1 further comprising a trailer engaged with the vertical jack whereby the vertical jack supports a load on the trailer.

3. The apparatus of claim 1 wherein the plural wheels are positioned outboard of the sidewall.

4. The apparatus of claim 3 wherein the sidewall is positioned relative to the wheels such that a downward force on the vertical jacking device is unable to tip the rolling dolly.

5. An apparatus comprising: a horizontal platform mounted on plural wheels, for rolling movement; a sidewall integral with the platform and forming a closed figure on a top surface thereof; a vertical jacking device having a jack foot positioned in contact with the top surface within the closed figure; the sidewall positioned relative to the wheels such that a downward force on the jacking device is central to upward forces of the wheels exerted by a supporting surface upon which the wheels are in rolling contact.

6. An apparatus comprising in combination: a horizontal platform mounted on plural wheels, for rolling movement of the platform; a sidewall integral with, and extending upwardly from a top surface of the platform and positioned centrally thereon; and a vertical jacking device having a jack foot positioned in contact with the platform surface and surrounded by the sidewall such that the jack foot is centrally positioned on the top surface, the sidewall having a height superior to a height of the jack foot so that the jack foot is constrained centrally on the platform by the sidewall; and a trailer rigidly engaged with the vertical jack for delivering a downward force centrally to the platform.

7. The apparatus of claim 6 wherein the trailer provides a trailer hitch proximal the vertical jack.

8. The apparatus of claim 6 wherein the wheels are caster wheels.

9. The apparatus of claim 8 wherein the sidewall is positioned relative to the caster wheels such that a downward force on the vertical jacking device is transferred to the platform centrally to the caster wheels.

10. A method of providing rolling support and manual mobility to a trailer comprising the steps of: initially connecting the trailer to a towing vehicle using a hitch; positioning the trailer using the towing vehicle; raising a jack foot of a vertical jacking device attached to the trailer; positioning a platform having wheels for rolling movement of the platform below the jack foot; lowering the jack foot into contact with the platform such that a sidewall integral with the platform surrounds the jack foot and is of a height to constrain the jack foot in a position on the platform such that downward forces on the jack foot are central to upward forces on the wheels; transferring weight of the trailer from the hitch to the platform; disengaging the trailer from the towing vehicle at the hitch; and positioning the trailer manually by moving the jacking device and trailer with the platform.
